(19) United States
(12) Patent Application Publication
(10) Pub. No.: US 2006/0087731 A1
(43) Pub. Date: Apr. 27, 2006

(54) Illumination apparatus and an endoscope with object illumination using the same

(75) Inventors: Masao Satoh, Saitama-shi (JP); Takashi Kusuhara, Saitama-shi (JP)

Correspondence Address: TOWNSEND & BANTA;c/o PORTFOLIO IP, PO BOX 52050, MINNEAPOLIS, MN, 55402, US

(73) Assignee: Moritex Corporation, Tokyo (JP)

(21) Appl. No.: 11/246,069

(22) Filed: Oct. 11, 2005

(30) Foreign Application Priority Data
Oct. 12, 2004 (JP) 2004-297051

(51) Int. Cl. G02B 21/06

(52) U.S. Cl. 359/389

(57) ABSTRACT

An illumination apparatus to be used, for example, for an endoscope capable of controlling an illumination light irradiated from a light source to an object by way of a light guide inserted through a probe without enlarging the size of the apparatus, the apparatus having a fixed diaphragm for outputting under restriction a bundle of optical beams diffusively irradiated from the light source at a predetermined angle, and a light control mechanism that increases or decreases the amount of a light passing through the fixed diaphragm by approaching or receding the light source to and from the fixed diaphragm.

### BACKGROUND OF THE INVENTION

1. Field of the Invention

The present invention concerns an illumination apparatus capable of controlling the amount of light to be outputted, and an endoscope with object illumination using the apparatus.

2. Statement of Related Art

An endoscope is used generally for industrial and medical uses in which a tubular probe for taking images from the top end is attached to a device main body for observing images of an object to be observed, and an illumination light is illuminated to an object to be observed (hereinafter simply referred to as an object) by way of a light guide inserted in a probe such that even a portion not illuminated by external light can also be observed.

An endoscope 41 shown in FIG. 4 includes a tubular probe 45 in which an image guide 43 and a light guide 44 each comprising a bundle of fibers are inserted individually and an illumination apparatus 47 for entering an illumination light irradiated from a light source 46 such as a high luminance LED to the light guide 44 and illuminating an illumination light to the object are attached to a main body 42 as an eyepiece for observing the images of the object, and also includes a camera 48 for photographing images taken by the image guide 43 and a display device 49 for displaying the images (refer to JP-A No. 2000-116599).

However, since the illumination apparatus 47 can not control the amount of the illumination light in accordance with the lightness at the periphery of the object, the light becomes sometimes insufficient or excessive depending on the material of the object or the circumstantial situation making it difficult to observe the object depending on the case.

In view of the above, it has been proposed as shown in FIG. 5, an illumination apparatus 52 having a light control mechanism 53 to be used for an endoscope 51 (refer to JP-A No. 2003-180631).

In the illumination apparatus 52, a variable diaphragm 54 is provided between a light incident end of a light guide 44 and a light source 46 to control the amount of light by rotating the diaphragm by a motor or the like thereby changing the area of aperture.

Further, as means for controlling the amount of light, it has been also known to use a light control filter in which a plurality of ND filters of different light transmittance are arranged circumferentially, or a light control filter formed with a slit with the aperture ratio being changed gradually along the circumferential direction or, further, a light control circuit for controlling the voltage supplied to the light source 46, in addition to the utilization of the variable diaphragm 54 described above.

However, in the variable diaphragm 54, while the area of aperture is changed by advancing or retracting a diaphragm blade to restrict the amount of light by narrowing the area of aperture or increase the amount of light by enlarging the aperture, since the diameter for the light incident end of the light guide 44 is delimited, the area of aperture has to be controlled within a range diametrically smaller than that of the diameter.

Accordingly, the range capable of controlling the amount of light is restricted and, in addition, since the light is not entered to a portion of the light guide when the amount of light is restricted, it results in a problem that the light can not be emitted uniformly.

Further, since the diameter of the light control filter is larger than that of the variable diaphragm, the size is inevitably increased further.

Particularly, in a case of a simple portable type as shown by the endoscope 41 in FIG. 4 in which images taken from the top end of the probe 45 are observed with naked eyes, since a large main body is not connected with an external illumination apparatus but an illumination apparatus 47 also used as a grip is generally attached to the main body 42, it has been desired to reduce the size of the illumination apparatus 47.

Further, in a case where the voltage to be applied is changed by using a light control circuit, this results in a problem that the color temperature of the illumination light changes in a case of using a high luminance white LED, and when it is intended to maintain the color temperature constant, not only the light control circuit is complicated but also this increases the cost.

### SUMMARY OF THE INVENTION

In view of the above, the present invention intends to enable light control in an extremely simple constitution without enlarging the size of an illumination apparatus to be used being attached, for example, to an endoscope.

The present invention provides an illumination apparatus for outputting a light irradiated from a light source, having a fixed diaphragm for outputting under restriction a bundle of optical beams diffusively irradiated from the light source at a predetermined angle, and a light control mechanism that increases or decreases the amount of a light passing through the fixed diaphragm by moving the light source relative to the fixed diaphragm.

The illumination apparatus according to the invention has the fixed diaphragm for outputting under restriction a bundle of optical beams irradiated diffusively from the light source at the predetermined angle and since the amount of light passing through the fixed diaphragm changes in inverse proportion to the square of the distance from the light source to the fixed diaphragm by moving the light source along the direction of the optical axis of the diaphragm such that it approaches to or recedes from the diaphragm by the light control mechanism, the amount of light can be controlled easily.

Further, since the intensity distribution of a light illuminated from the light source is generally higher at the center (optical axis), and lowered as receding from the center, the intensity distribution of the light passing through the fixed diaphragm is changed by moving the optical axis of the light source so as to be inclined relative to the optical axis of the fixed diaphragm, and the amount of light can be controlled easily.

Further, since the diaphragm is fixed, it requires no precision operation mechanism for retracting the diaphragm blade and it may suffice to provide merely a simple mechanism for moving the light source, the illumination apparatus per se can be reduced in the size and the weight and simplified in the structure.

In preferred embodiments of the invention, the subject of enabling the light control without enlarging the size of the illumination apparatus to be used, for example, in an endoscope has been attained with an extremely simple constitution.

### DESCRIPTION OF THE ACCOMPANYING DRAWINGS

FIG. 1 is an explanatory view showing an endoscope according to the invention.

FIG. 2 is an explanatory view showing another embodiment.

FIG. 3 is an explanatory view showing a further embodiment.

FIG. 4 is an explanatory view showing an existent apparatus.

FIG. 5 is an explanatory view showing an existent apparatus.

### DESCRIPTION OF PREFERRED EMBODIMENTS

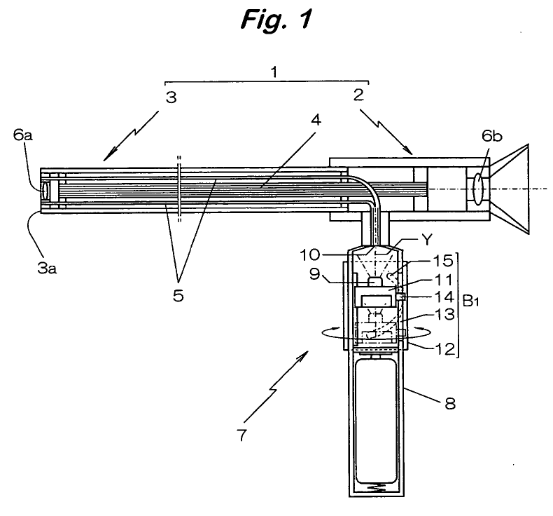

An endoscope 1 shown in FIG. 1 has an eyepiece (main body 2) for observing images of an object, to which a tubular probe 3 for taking images from the top end is attached.

An image guide 4 and a light guide 5 each formed of a bundle of optical fibers are inserted in the probe 3.

Then, an objective lens 6a for taking images of an object is disposed at the top end 3a of the probe of the image guide 4, and an ocular lens 6b for observing under magnification images taken from the objective lens 6a is disposed on the side of the eyepiece 2.

Further, a light guide 5 for irradiating a illumination light to the object is arranged in a ring-like manner at the periphery of the objective lens 6a.

An illumination apparatus 7 for irradiating an illumination light to the object by way of the light guide 5 is attached to the eyepiece 2.

The illumination apparatus 7 has, in a casing 8 used both as a grip for the endoscope 1, a diffusion light irradiating light source 9 such as a high luminance white LED for irradiating a bundle of optical beams at a predetermined angle and, a fixed diaphragm 10 for outputting the bundle of optical beams under restriction to the eyepiece 2, and a light control mechanism B, for controlling the amount of an illumination light outputted from the fixed diaphragm 10, and the light guide 5 is attached at its light incident end to the fixed diaphragm 10 being aligned with the optical axis Y.

The light control mechanism B, has a slider 11 mounted with a light source 9, and a slider advancing and retracting operation ring 12 attached externally to the casing 8 in which the slider 11 is advanced or retracted along the direction Y of the optical axis of the fixed diaphragm 10 in a state where the optical axes of the light source 9 and the fixed diaphragm 10 are arranged coaxially.

Further, a pin 14 protruding outward from a slit 13 formed in the longitudinal direction of the casing 8 of the illumination apparatus 7 is attached to the slider 11 and the pin 14 is engaged with a spiral groove 15 formed to the inner surface of the operation ring 12.

Thus, when the operation ring 12 is rotated, it acts as a cylindrical cam and enables the light source 9 attached to the slider 11 to advance or retract along the direction of the optical axis Y.

Then, among the bundle of optical beams irradiated diffusively at a predetermined angle, since the amount of the light passing through the fixed diaphragm 10 increases when the light source 9 approaches to the fixed diaphragm 10 whereas the amount of light passing through the fixed diaphragm decreases when the light source 9 recedes from the fixed diaphragm 10, the amount of the illumination light illuminated by way of the light guide 5 to the object can be controlled.

An example of the constitution of the present invention is as has been described above and the operation thereof is to be explained.

For example, description is to be made in the case of conducting maintenance for machinery equipments or car engines, where a portion difficult to be seen being hidden behind gaps of intricately assembled parts or the inside of the pipe line is observed.

At first, in a state of lighting up the light source 9 of the illumination apparatus 7, when the probe 3 is enforced into a portion to be observed, the illumination light irradiated from the light source 9 is irradiated from the top end by way of the light guide 5 to the object.

Accordingly, since the illumination light is irradiated even when the periphery of the object is dark, the images can be taken from the top end of the image guide 4 and can be observed by the eyepiece 2.

By the way, in a case where the object is formed of a material highly reflecting the light, the intensity of a reflection light of the illumination light irradiated from the top end 3a of the probe 3 is excessively high and the images sometimes cause halation when observed by the eyepiece 2 and rather becomes difficult to be seen.

In such a case, when the slider 11 to which the light source 9 is attached is retracted from the fixed diaphragm 10 by rotating the operation ring 12 of the illumination apparatus 7, since the amount of light passing through the fixed diaphragm 10, among the bundle of optical beams irradiated diffusively at a predetermined angle from the light source 9, is decreased, the amount of the light can be decreased.

Further, in a case where the object is formed of a material less reflecting the light, the intensity of the reflection light of the illumination light irradiated from the top end 3a from the probe 3 is insufficient and the images are sometimes difficult to be seen when observed by the eyepiece 2.

In such a case, when the slider 11 to which the light source 9 is attached is advanced so as to approach the fixed diaphragm 10 by rotating the operation ring 12 of the illumination apparatus 7, since the amount of light passing through the fixed diaphragm 10, among the beam of light diffusively irradiated from the light source 9 at a predetermined angle, is increased, the amount of the light can be increased.

As described above, according to this embodiment, the illumination light can be controlled to an appropriate amount of the light by rotating the operation ring 12 of the illumination apparatus 7 under monitoring by the eyepiece 2.

The eyepiece 2 is not restricted to those conducting observation with naked eyes but it may be those incorporated with an image pick-up device and conducting observation by displaying images on a monitor.

Further, the illumination apparatus 7 is not restricted to those used for the illumination of the endoscope 1 with objection illumination but also usable as a general-purpose illumination apparatus.

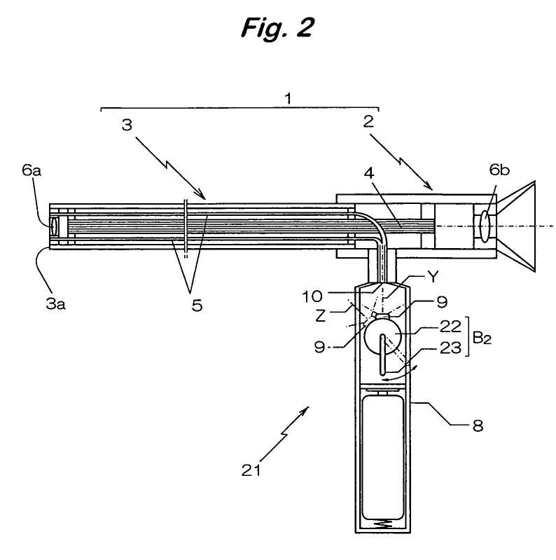

FIG. 2 shows another embodiment in which the portions in common with those in FIG. 1 carry identical reference numerals for which detailed descriptions are to be omitted.

The illumination apparatus 21 of this embodiment has a diffusive light illumination light source 9, a fixed diaphragm 10, and a light control mechanism B₂ in a casing 8 which is used both as a grip.

The light control mechanism B₂ has a swinging member 22 to which the light source 9 is attached and an operating member 23 for causing the member 22 to swing, and the optical axis Z of the light source 9 can be inclined relative to the optical axis Y of the fixed diaphragm 10 by rotating the operating member 23.

Since the intensity distribution of the light irradiated from the light source 9 is higher at the center (direction of optical axis Z), and is darkened as it recedes from the optical axis Z, and the intensity distribution of the light transmitting through the fixed diaphragm 10 changes by moving the optical axis Z of the light source 9 so as to incline it relative to the optical axis Y of the fixed diaphragm 10, the amount of light can be controlled easily.

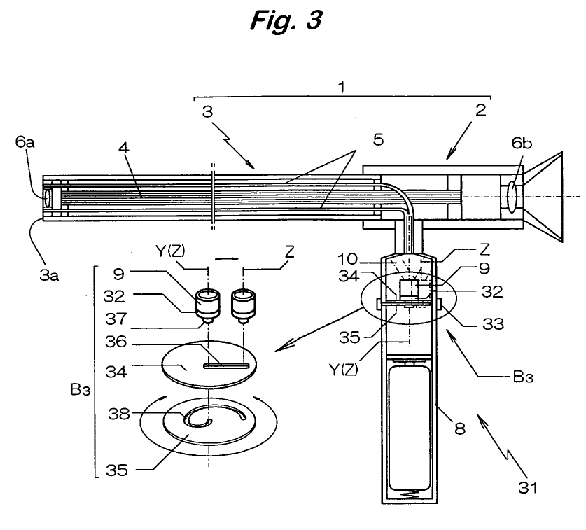

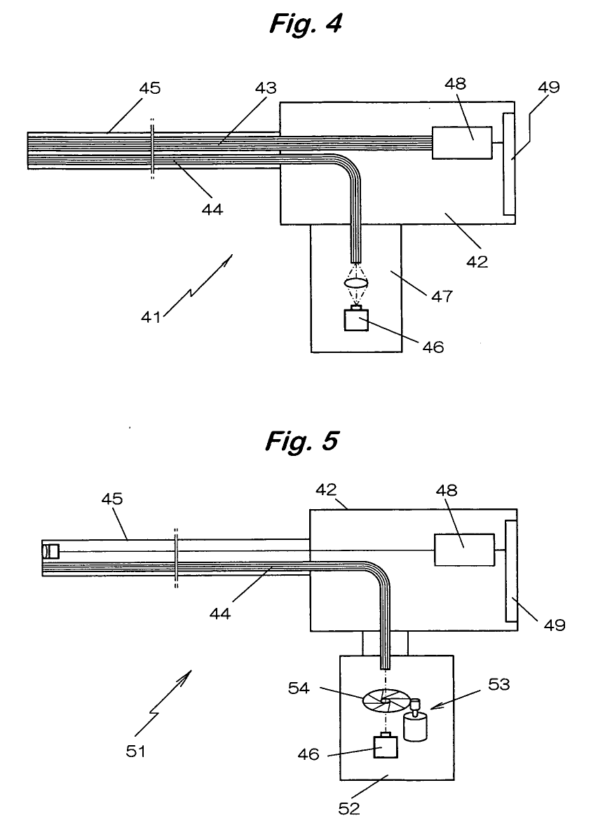

FIG. 3 shows a further embodiment in which portions in common with those in FIG. 1 carry identical reference numerals, for which detailed descriptions are to be omitted.

The illumination apparatus 31 of this embodiment has a diffusive light illumination light source 9, a fixed diaphragm 10, and a light control mechanism B₃ in a casing 8 that is used both as a grip in which the light source 9 and the fixed diaphragm 10 are arranged with the optical axes Z and Y thereof in parallel with each other.

The light control mechanism B₃ has a slider 32 advancing or retracting in the direction perpendicular to the optical axis Y of the fixed diaphragm 10, and an operation ring 33 for advancing or retracting the slider attached externally to the casing 8, in which the light source 9 is attached to the slider 32 and located so that it can be displaced related to the optical axis Y of the fixed diaphragm 10.

Further, a fixed disc 34 and a rotational disc 35 are disposed being stacked to each other on a plane perpendicular to the optical axis Y in the casing 8 of the illumination apparatus 7, a pin 37 penetrating a slit 36 formed in the radial direction of the fixed disc 34 is attached to the slider 32 and the pin 37 is engaged with a spiral slit 38 formed to the rotational disc 35.

Then, the rotary disc 35 is attached to the operation ring 33, the light source 9 is advanced or retracted in the direction perpendicular to the optical axis Y of the fixed diaphragm 10 by the rotation of the operation ring 33, and the optical axis Z of the light source 9 is displaced relative to the optical axis Y of the fixed diaphragm 10.

Also in this embodiment, the intensity distribution of the light illuminated from the light source 9 is utilized, and the illumination light is most bright when the optical axis Z of the light source 9 is at a coaxial position relative to the optical axis Y of the fixed diaphragm 10 and the illumination light becomes darker as the optical axis Z of the light source 9 recedes from the optical axis Y of the fixed diaphragm 10.

As has been described above, the present invention is applicable as illumination apparatus to be used in a case of observing a portion difficult to be seen being hidden behind gaps of parts, inside of the pipe line or body tract while controlling the amount of illumination light in accordance with the material of the object and the circumstance of the observation position, for example, in the fields of general industry and medical fields.

The present disclosure relates to subject matter contained in priority Japanese Patent Application No. 2004-297,051 filed on Oct. 12, 2004, the contents of which is herein expressly incorporated by reference in its entirety.

What is claimed is:

1. An illumination apparatus for outputting a light irradiated from a light source, having a fixed diaphragm for outputting under restriction a bundle of optical beams diffusively irradiated from the light source at a predetermined angle, and a light control mechanism that increases or decreases the amount of a light passing through the fixed diaphragm by moving the light source relative to the fixed diaphragm.

2. An illumination apparatus according to the claim 1, wherein,
the light source and the fixed diaphragm are located with the optical axes thereof being coaxial with each other, and the light source is located such that it can approach to or recede from the fixed diaphragm in the light control mechanism.

3. An illumination apparatus according to the claim 1, wherein,
the light source is located such that the optical axis thereof can be inclined relative to the optical axis of fixed diaphragm in the light control mechanism.

4. An illumination apparatus according to the claim 1, wherein,
the light source and the fixed diaphragm are located with the optical axes thereof being kept in parallel with each other and the light source is located such that it can be displaced relative to the optical axis of the fixed diaphragm.

5. An endoscope with object illumination in which a tubular probe that takes images from the top end, and an illumination apparatus for irradiating an illumination light by way of a light guide inserted through the probe to an object to be observed are attached to a main body for observing the images of the object, wherein the illumination device has a fixed diaphragm for outputting under restriction a bundle of optical beams diffusively irradiated from the light source at a predetermined angle, and a light control mechanism that increases or decreases the amount of a light passing through the fixed diaphragm by moving the light source relative to the fixed diaphragm.
